(19) United States
(12) Patent Application Publication
(10) Pub. No.: US 2008/0313290 A1
(43) Pub. Date: Dec. 18, 2008

(54) IMAGE FORMING APPARATUS AND ELECTRONIC MAIL PROCCESSING METHOD THEREOF

(75) Inventor: SEONG-IL PARK, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/039,017

(22) Filed: Feb. 28, 2008

(30) Foreign Application Priority Data
Jun. 15, 2007 (KR) 2007-59107

(51) Int. Cl. G06F 15/16

(52) U.S. Cl. 709/206

(57) ABSTRACT

An image forming apparatus including: a data generator to generate image data; an email writing unit to write an email including the generated image data; a user interface unit to display a user interface, which enables a user to select email transmission options, if the image data exceeds a file size limitation information of a mail server to receive the email; and a controller to control the email writing unit to write the email, according to the transmission option(s) selected through the user interface.

### CROSS-REFERENCE TO RELATED APPLICATION

This application claims the benefit of Korean Application No. 2007-59107, filed Jun. 15, 2007, in the Korean Intellectual Property Office, the disclosure of which is incorporated herein by reference.

### BACKGROUND OF THE INVENTION

1. Field of the Invention

Aspects of the present invention relate to an image forming apparatus and an electronic mail processing method thereof, and more particularly, to an image forming apparatus and an electronic mail processing method therefor, in which transmission options can be selected through a user interface, if image data exceeds file size limitation information of a mail server.

2. Description of the Related Art

With the rapid expansion of Internet-related industries, Internet-related methods and products have been developed and become widespread. One such Internet-related product is a network image forming apparatus. An image forming apparatus refers to an apparatus that forms an image on a printing medium, for example, a copier, a facsimile, a printer, or a multifunctional apparatus. The network image forming apparatus refers to an image forming apparatus having a network card mounted therein, to transmit and receive data through a network.

Recently, network image forming apparatuses gained electronic mail (email) functionalities, allowing for documents to be sent and received, via the Internet, instead of a public telephone network.

Hereinafter, an email transmitting method of a conventional image forming apparatus will be described. The image forming apparatus receives an email address of an email recipient and information on the maximum file size that may be sent to the recipient, and stores the received address and information in a memory.

When the email transmission function is selected, the image forming apparatus sends an email, which includes data generated by scanning a document. If the completed email does not exceed the maximum file size, the image forming apparatus immediately transmits the completed email to the recipient. If the completed email exceeds the maximum transferable file size, the image forming apparatus divides the email into sections that are smaller than, or equal to, the maximum transferable file size, and transmits each section to the recipient.

As described above, the conventional email transmitting method can prevent an email from exceeding the maximum file size of a mail server. However, the email may be divided unnecessarily, or the transmission of the email may fail, due to a difference between the maximum transferable file size set by a user, and the maximum transferable size that may actually be transmitted or received, via a mail server. Additionally, there is a problem that the recipient's mail server may not be able to receive the email, when the recipient's mailbox is full.

### SUMMARY OF THE INVENTION

Aspects of the present invention relate to an image forming apparatus and an email transmitting method including the use of transmission options that are selectable through a user interface, if the size of an emailed file exceeds file size limitation information of a recipient's mail server.

Aspects of the present invention also relate to an image forming apparatus and a method thereof, in which a user can check file size limitation information, without needing to manually input a maximum file size, or checking an effective mailbox storage capacity.

According to an aspect of the present invention, there is provided an image forming apparatus including: a data generator to generate image data; an email writing unit to write an email including the generated image data; a user interface unit to display a user interface to select email transmission options, if the image data exceeds a maximum file size of a recipient's mail server; and a controller to control the email writing unit, to write the email according to the transmission option(s) selected through the user interface.

According to aspects of the present invention, the image forming apparatus may include: an input unit to receive an email address of the mail server; a communication unit to request and receive file size limitation information from the recipient's mail server, through the input email address; and a storage unit to store the received file size limitation information.

According to aspects of the present invention, the file size limitation information may be requested at any time before, during, and after generation of the image data, or when the generation of a single page of the image data is complete.

According to aspects of the present invention, if the size of a currently generated amount of the image data exceeds the file size limitation information, when the data generator generates image data, the controller may control the user interface unit to display a warning message.

According to aspects of the present invention, the file size limitation information may include a maximum file size and/or an effective mailbox storage capacity, of the recipient's mail server.

According to aspects of the present invention, the user interface may include a message display field to display a warning message and a selection field to select the transmission options.

According to aspects of the present invention, the user interface may include a first selection subfield, the selection of which causes the image data to be divided and/or compressed, so as to have a size no greater than the file size limitation information, and to be transmitted in a divided and/or compressed state; a second selection subfield, the selection of which causes only the image data already generated to be transmitted; a third selection subfield, the selection of which causes the format of the image data to be converted, so that the image data has a size no greater than the file size limitation information; and a fourth selection subfield, the selection of which cancels the transmission of the image data.

According to aspects of the present invention, the first to third selection subfields may be selected in any combination.

According to another aspect of the present invention, there is provided an email processing method including: generating image data; detecting file size limitation information of a recipient's mail server; and displaying a user interface to select transmission operations to be applied to an email including the generated image data, if the generated image data exceeds the file size limitation information.

According to aspects of the present invention, the method may further include: writing the email, according to selected transmission operation(s); and transmitting the email to the mail server.

According to aspects of the present invention, the method may include requesting the file size limitation information from the recipient's mail server, using an email address of the mail server.

According to aspects of the present invention, the file size limitation information may be requested at any time before, during, and after generation of the image data, or when generation of a single page of the image data is complete.

According to aspects of the present invention, if the size of a generated portion of the image data exceeds the file size limitation information, a warning message is displayed.

According to aspects of the present invention, the file size limitation information may include a maximum file size and/or an effective mailbox storage capacity, of the mail server.

According to aspects of the present invention, the user interface may include a message display field to display a warning message, and a selection field to select the transmission options.

According to aspects of the present invention, the user interface may include: a first selection subfield comprising an option to divide and/or compress the image data, so as to be less than the file size limitation information of the recipient's mail server, and to then be transmitted; a second selection subfield comprising an option to transmit a currently generated portion of the image data; a third selection subfield comprising an option to convert the format of the image data, so as to be smaller than the file size limitation information; and a fourth selection subfield comprising an option to cancel the transmission of the image data.

According to aspects of the present invention, the first to third selection subfields may be selected in any combination.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a block diagram illustrating the configuration of an image forming apparatus, according to an exemplary embodiment of the present invention;

FIG. 2 is a block diagram illustrating an image forming apparatus, according to an exemplary embodiment of the present invention;

FIGS. 3, 4A, and 4B are views showing user interfaces, according to exemplary embodiments of the present invention;

FIG. 5 is a flowchart illustrating an email processing method of an image forming apparatus, according to an exemplary embodiment of the present invention;

FIG. 6 is a flowchart illustrating an email processing method, according to an exemplary embodiment of the present invention; and

FIG. 7 is a flowchart illustrating an initial setting for the transmission of an email, according to an exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present general inventive concept, by referring to the figures.

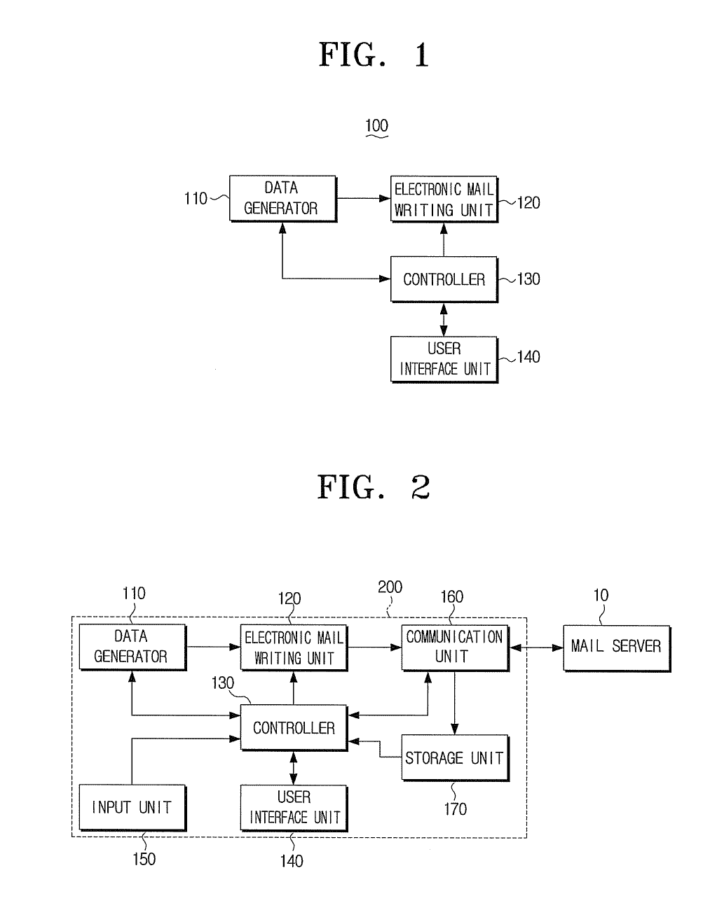

FIG. 1 is a block diagram illustrating the configuration of an image forming apparatus 100, according to an exemplary embodiment of the present invention. In FIG. 1, the image forming apparatus 100 includes a data generator 110, an email writing unit 120, a controller 130, and a user interface unit 140.

The data generator 110 scans a document to generate image data. The email writing unit 120 writes an email that includes the image data. The data generator 110 and email writing unit 120 may be controlled by the controller 130 and/or the user interface unit 140.

The controller 130 may compare the size of the image data and a maximum file size of a mail server. If the size of the image data exceeds the maximum file size, the controller 130 may control the user interface unit 140, such that a user interface is displayed. In this situation, the data generator 110 may be operated in a standby mode, or in a sleep mode.

The controller 130 can determine the maximum file size, by referring to file size limitation information of the mail server. The file size limitation information may include the maximum file size of the mail server, and an effective mailbox storage capacity of a particular mail box on the mail server, which corresponds to an email address. The maximum file size can relate to the largest file that the mail server will accept.

The user interface unit 140 may provide a user with various transmission options, to transmit the image data generated by the data generator 110. The user interface unit 140 may generate a user interface, through which a user can select one or more of the transmission options.

The user interface may include a message display field to display a warning message, and a selection field to display the transmission options. A user can select one or more of the options from the selection field.

The selection field may include a first selection subfield, a second selection subfield, a third selection subfield, and a fourth selection subfield. One or more of the selection subfields may be selected to configure the transmission of the image data. The first selection subfield may be selected, in order to divide and/or compress the image data, to a size equal to, or less than, the maximum file size of the recipient's mail server, and to transmit the divided and/or compressed data. The second selection subfield may be selected, in order to transmit only a currently generated portion of the image data. The third selection subfield may be selected, in order to convert the format of the image data, so that the image data is no larger than the maximum file size. The fourth selection subfield may be selected, in order to cancel the transmission of the image data.

The controller 130 may control the email writing unit 120 to write an email, according to the transmission options selected through the user interface unit 140. In other words, the email writing unit 120 may write the email, such that the email does not exceed the maximum file size and/or the effective mailbox storage capacity, of the mail server. Accordingly, it is possible to prevent a transmission failure when transmitting the email.

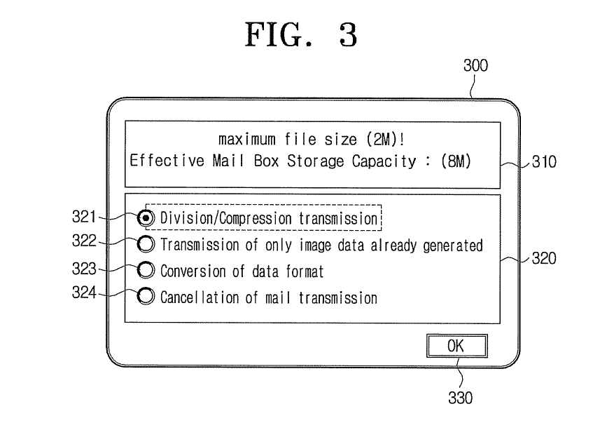

FIG. 2 is a block diagram illustrating the configuration of the image forming apparatus 200, according to an exemplary embodiment of the present invention. As shown in FIG. 2, the image forming apparatus 200 includes an input unit 150, a communication unit 160, and a storage unit 170, in addition to the elements shown in the image forming apparatus 100, of FIG. 1.

The communication unit 160 connects the image forming apparatus to an external mail server 10. The input unit 150 can be used by a user, to input commands to control various operations supported by the image forming apparatus 200. The input unit 150 may include, for example, a plurality of buttons, and/or a touch screen, through which the user inputs the commands. The input unit 150 can be used to input an email address and an email transmission command, in order to transmit an email to an email address.

The communication unit 160 can be connected to a network (not shown), to enable communication between an external device (not shown) and the mail server 10, via the image forming apparatus 200. Specifically, the communication unit 160 may transmit and receive email, through the mail server 10. The mail server 10 can support a simple mail transfer protocol (SMTP) and a post office protocol 3 (POP3). The SMTP supervises transmission of email, while POP3 supervises reception of email. In other words, if a user desires to transmit an email through the mail server 10, the email may be transmitted to the mail server 10, using the SMTP.

If an email transmission command is input through the input unit 150, the controller 130 may control the communication unit 160, to request file size limitation information from the mail server 10. The file size limitation information can include a maximum file size set by the mail server 10, and an effective mailbox storage capacity of a mailbox of the mail server 10, which is associated with a particular email address. The controller 130 may also control the data generator 110, to generate image data from a document to be transmitted.

The file size limitation information may be requested, according to a user-defined setting, at any time before, during, and/or after the generation of image data. For example, the file size information can be requested when a single page of the image data is generated. In other words, it is possible to request the file size limitation information at any time before, during, and/or after scanning, or when the scanning of a single page of the image data is completed, by the data generator 110.

The controller 130 may be connected with the storage unit 170, which is to store the file size limitation information of the mail server 10. The controller can include a storage unit (not shown) to store the image data generated by the data generator 110.

The email address and the file size limitation information may be stored together. If the email is completely transmitted, the effective mailbox storage capacity may be deleted from the file size limitation information. In other words, if the email transmission command for a pre-stored email address is input, only the effective mailbox storage capacity of the mail server 10 may be checked.

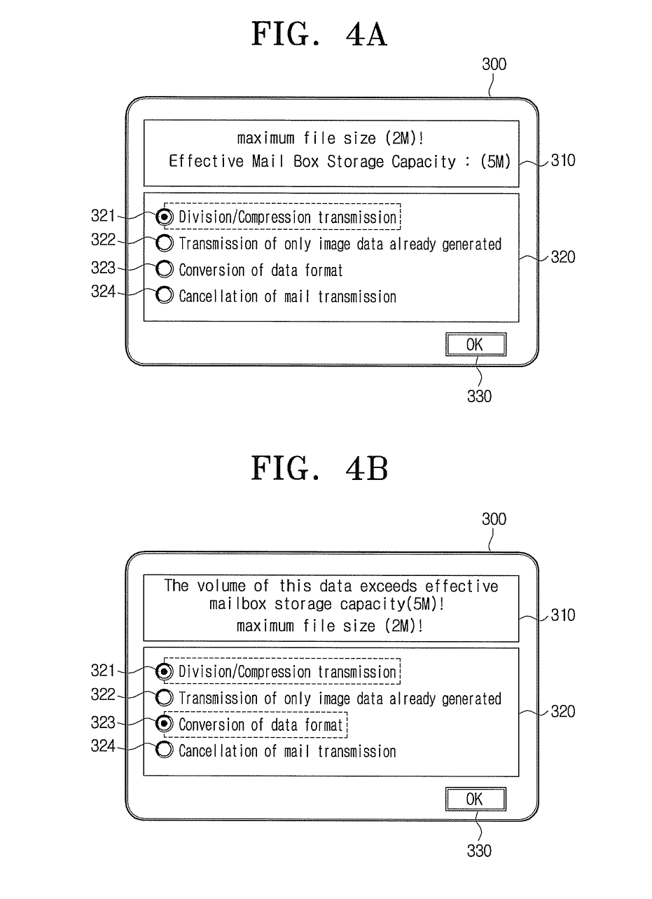

The controller 130 may compare the stored file size limitation information, to a portion of the image data generated by the data generator 110. If the portion of the image data exceeds the file size limitation information, for example, the maximum file size, the controller 130 provides a user interface, to display transmission options. The transmission options can be used to configure the transmission of the email. The user interface is described in detail below, with reference to FIGS. 3, 4A and 4B.

FIGS. 3, 4A, and 4B are views showing examples of a user interface 300, according to an exemplary embodiment of the present invention. As shown in FIGS. 3, 4A, and 4B, the user interface 300 may include a warning message display field 310, a selection field 320, and a confirmation field 330. The selection field 320 may include a first selection subfield 321, a second selection subfield 322, a third selection subfield 323, and a fourth selection subfield 324.

The selection field 320 displays transmission options in the first-fourth subfields 312-324. The first to third selection subfields 321-323 may be selected singly, or in any combination. In other words, the transmission method can encompass any combination of the options displayed in the first to third selection subfields 321-323, according to which of the subfields 321-323 are selected. The fourth subfield is used to cancel an email transmission.

The confirmation field 330 displays a confirmation message, i.e., an “OK”. A user can select the confirmation field 330, to confirm the options selected from the selection field 320.

The user interface 300 of FIG. 3 may be displayed, when the size of the image data exceeds the maximum file size and/or effective mailbox capacity. Here, it is assumed that the total size of the image data is approximately 7.5 MB, the maximum file size of the recipient's mail server is approximately 2 MB, and the effective mailbox storage capacity is approximately 8 MB. If the email transmission command is input, image data, corresponding to the document to be transmitted, may be generated.

If the size of the image data exceeds the 2 MB maximum file size, at any point during the generation of the image data, the warning message 310 may be displayed. The selection field 320 may also be displayed, so that a user can select one or more transmission options, after which the warning message may be removed.

In FIG. 3, the first selection subfield 321 is selected, which relates to the division/compression transmission option. In this situation, the data generator 110, which has been, for example, in the standby mode or in the sleep mode, is actuated, and generates image data corresponding to the document to be transmitted. For example, if 7.5 MB of image data is generated, the email may be transmitted using one of the transmission options, such as, division and/or compression of the image data into portions of 2 MB, or less.

If the second selection subfield 322 is selected, only a currently generated portion of the image data may be transmitted. In other words, only 2 MB, or less, of the image data is transmitted, even if a total amount of the image data is larger than 2 MB.

In FIGS. 4A and 4B, it is assumed that approximately 7.5 MB of the image data is to be transmitted, the maximum file size of the recipient's mail server is approximately 2 MB, and the effective mailbox storage capacity is approximately 5 MB, according to an exemplary embodiment of the present invention. In this situation, the user interface 300 may be sequentially altered, as shown in FIG. 4A and FIG. 4B.

As shown in FIG. 4A, if the size of the image data exceeds the 2 MB maximum file size, during the generation of the image data, the warning message display field 310 and the transmission options selection display field 320 may appear. The user interface of FIG. 4A is similar to the user interface of FIG. 3, so a detailed description thereof is omitted.

If the image data exceeds the 5 MB effective mailbox storage capacity, during the generation of the image data, the warning message display field 310 and the selection field 320 may be displayed. In FIG. 4A, the first selection subfield 321 is shown as having been selected.

The first selection subfield 321, the second selection subfield 322, and the third selection subfield 323 may be selected singly or in any combination, for example, the combination shown in FIG. 4B. If the confirmation field 330 is selected, the data generator 110 is actuated to, for example, generate 7.5 MB of image data. The data generator 110 then converts the image data into a compressed data format, such that the image data is reduced to 5 MB, or less (the effective mailbox storage capacity). Additionally, the email may be transmitted using one of the other transmission options, such as, the division and/or compression into portions of 2 MB, or less.

If a user knows the total size (e.g., 7.5 MB) of the image data, he or she may select one or more of the first to third subfields 321 to 323, so that a transmittable email can be written immediately, for example, while the image data is being generated.

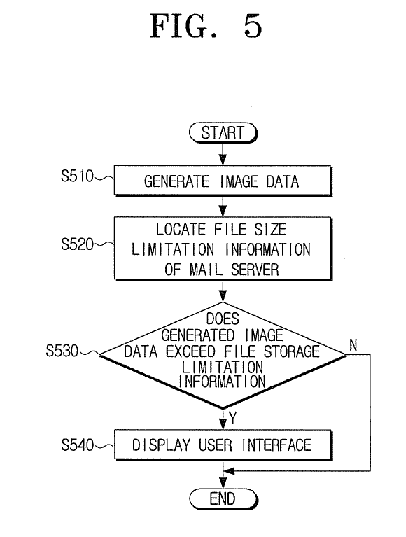

FIG. 5 is a flowchart illustrating an email processing method in an image forming apparatus, according to an exemplary embodiment of the present invention. In FIG. 5, scanning of a document is commenced, thereby generating image data, in operation S510.

File size limitation information of a mail server is retrieved, in operation S520. The file size limitation information may include the maximum file size and the effective mailbox storage capacity, of a mail server to receive the image data. The file size limitation information can include/relate to an email address of the mail server.

In operation S530, a current amount of image data is compared to the file size limitation information. If the current amount of image data is less than the file size limitation information, an email including the generated image data may be written, and may then be transmitted to the recipient's mail server. If the current amount of image data exceeds the file size limitation information, the method can proceed to operation 540.

In operation 540, the user interface is displayed, so that the user may select one or more of the transmission options. A warning message may by displayed in the message display field 310, to inform a user that the current amount of image data exceeds the file size limitation information. The selection fields 321-324 are displayed, to provide the transmission options to the user.

The user can select one or more of the transmission options, and then use the confirmation field to confirm the selection. Once the confirmation is input, an email is written, which does not exceed the file size limitation information of the mail server.

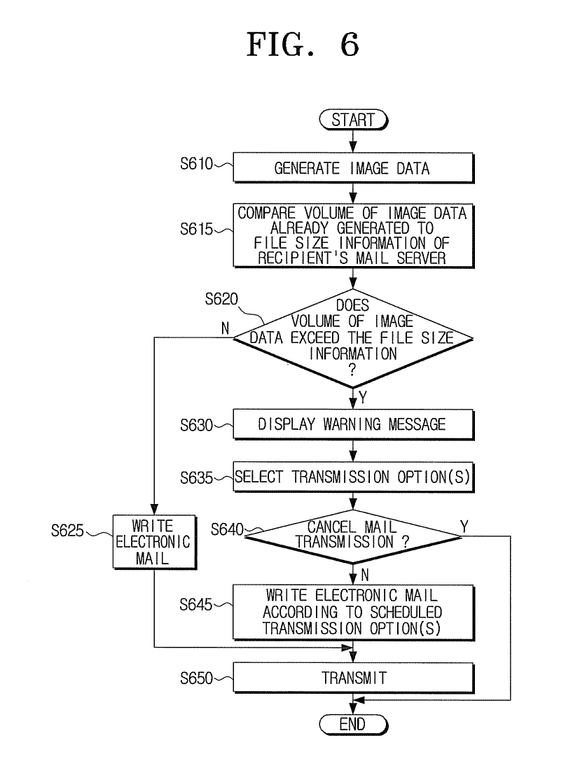

FIG. 6 is a flowchart illustrating an exemplary email processing method. As shown in FIG. 6, scanning of a document is commenced, thereby generating image data, in operation S610. In operation S615, file size limitation information of a mail server is detected. The file size limitation information relates to an email address of the mail server. The file size limitation information can be detected by sending a request to the mail server.

In operation S620, the image data, or a currently generated amount thereof, is compared to the file size limitation information. If the generated image data is less than the file size limitation information, an email corresponding to the generated image data may be written, in operation S625, and may be then transmitted to the mail server, in operation S650.

If the amount of the image data is determined to exceed the file size limitation information, a warning message including the file size limitation information, and a warning that the size of the generated image data already exceeds the file size limitation information, is displayed, in operation S630. In this situation, the warning message may be displayed together with the transmission options, in order that the user may select at least one of the transmission options, to enable the email to be successfully transmitted.

The user interface may include: a first selection subfield, which displays an option where the generated image data is divided and/or compressed, so as to be no greater than the file size limitation information, and then transmitted in the divided and/or compressed state; a second selection subfield, which displays an option to transmit the image data already generated; a third selection subfield, which displays an option to convert the format of the image data to be converted, so that the image data is no greater than the file size limitation information; and a fourth selection subfield, which displays an option to cancel the transmission of the image data.

The transmission options may be selected through the user interface, in operation S635. The first to third selection subfields may be selected concurrently, i.e., in any combination.

In operation S640, a determination is made, as to whether the fourth selection subfield 324 was selected in operation S635. If so, the writing of the email is terminated, and the method ends. Alternatively, if the fourth selection subfield 324 was not selected (i.e., one or more of the first to third selection subfields were selected), the method proceeds to operation S645.

In operation S645, an email is written and transmitted, according to the selected transmission option(s). Specifically, an email may be written according to at least one of the transmission options, such as, the division and/or compression of the current amount of image data. The written email may then be transmitted to the mail server, in operation S650. For example, if the division and/or compression transmission technology is selected and if the technology of transmission of only the image data already generated is also selected, the generated image data may be divided and/or compressed, so that an email may be written, in operation S645.

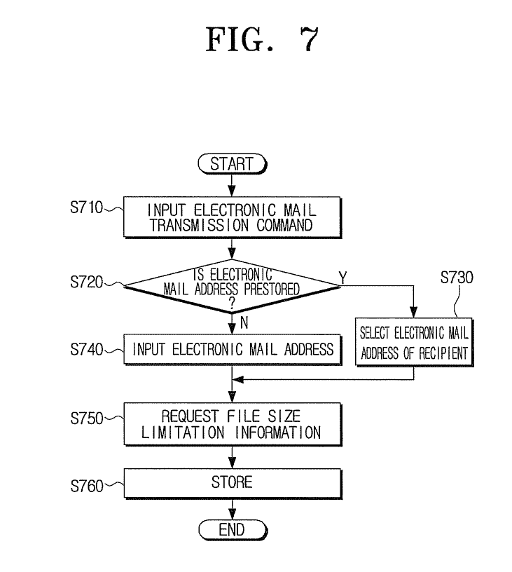

FIG. 7 is a flowchart illustrating an initial setting for transmission of an email. In operation S710, an email transmission command is input. In operation S720-Y, an email address can be selected from pre-stored email addresses. If the email address is one of the pre-stored email addresses, the email address may be selected, in operation S730. Alternatively, if the email address is not stored, the method proceeds to operation S720-N, where a user may input the email address, in operation S740.

In operation S750, file size limitation information may be requested from a mail server. The file size limitation information can be requested using the email address. The file size limitation information may be requested at any time before, during, and after generation of image data that may be included in the email, or when the generation of a single page of the image data is completed.

If the requested file size limitation information is received, the file size limitation information may be stored, in operation S760. In this situation, the email address and the file size limitation information may be stored together.

As described above, according to the exemplary embodiments of the present invention, if the size of the image data exceeds the file size limitation information of the recipient's mail server, the selectable transmission methods may be provided through the user interface, so that it is possible to prevent failure in transmitting the email.

Additionally, if the file size limitation information, corresponding to the email address, is received from the mail server, the user may not be required to input the maximum file size, or to check the effective mailbox storage capacity, in order to know the correct file size limitation information.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion.

Although a few exemplary embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus comprising:
a data generator to generate image data;
an email writing unit to write an email comprising the generated image data, to be transmitted to a mail server;
a controller to control the email writing unit, such that the email writing unit writes the email according to one or more selected transmission options, if the generated image data is greater than file size limitation information of the mail server; and
a user interface unit to display a user interface to select one or more of the transmission options.

2. The image forming apparatus of claim 1, further comprising:
an input unit to receive an email address of the mail server;
a communication unit to receive file size limitation information, which corresponds to the email address, from the mail server; and
a storage unit to store the detected file size limitation information.

3. The image forming apparatus of claim 2, wherein the file size limitation information is detected before, during, or after the generation of the image data.

4. The image forming apparatus of claim 1, wherein the user interface unit displays a warning message display field in the user interface, when the generated image data exceeds the file size limitation information.

5. The image forming apparatus of claim 1, wherein the file size limitation information comprises at least one of a maximum file size of the mail server, and an effective mailbox storage capacity corresponding to an email address of the mail server.

6. The image forming apparatus of claim 1, wherein the user interface comprises a message display field to display a warning message, and a selection field to display the transmission options.

7. The image forming apparatus of claim 1, wherein the user interface comprises:
a first selection subfield comprising a transmission option to divide and/or compress the image data to be no greater than the file size limitation information, and then to transmit the image data to the mail server;
a second selection subfield comprising a transmission option to transmit a currently generated amount of the image data;
a third selection subfield comprising a transmission option to convert the format of the image data, such that the converted image data is no greater than the file size limitation information, and then to transmit the image data to the mail server; and
a fourth selection subfield comprising a transmission option to cancel the transmission of the image data.

8. The image forming apparatus of claim 7, wherein the first to third selection subfields are selectable in any combination.

9. An email processing method comprising:
generating image data;
detecting file size limitation information of a mail server to receive the image data; and
displaying a user interface to select one or more transmission options to transmit the image data to the mail server in an email, when the generated image data exceeds the file size limitation information.

10. The method of claim 9, further comprising writing the email, according to the one or more options selected through the user interface, and then transmitting the email to the mail server.

11. The method of claim 9, wherein the detecting of the file size limitation information comprises requesting the file size limitation information from the mail server, using an email address associated with the mail server.

12. The method of claim 11, wherein the file size limitation information is requested before, during, or after the generating of the image data.

13. The method of claim 9, wherein, the displaying of the user interface comprises displaying a warning message, when the generated image data exceeds the file size limitation information.

14. The method of claim 9, wherein the file size limitation information comprises at least one of a maximum file size of the mail server, and an effective mailbox storage capacity associated with an email address of the mail server.

15. The method of claim 9, wherein the user interface comprises a message display field to display a warning message, and a selection field to select the options.

16. The method of claim 9, wherein the user interface comprises:
a first selection subfield comprising an option to divide and/or compress the image data to be no greater than the file size limitation information, and then transmitting the image data to the mail server;
a second selection subfield comprising an option to transmit a currently generated amount of the image data;
a third selection subfield comprising an option to convert the format of the image data, such that the converted image data is no greater than the file size limitation information, and then to be transmitted to the mail server; and
a fourth selection subfield comprising an option to cancel the transmission of the image data.

17. The method of claim 16, wherein the first to third selection subfields are selectable in any combination.

18. The image forming apparatus of claim 2, wherein the file size limitation information is requested after the generation of a single page of the image data.

19. The method of claim 11, wherein the file size limitation information is requested after the generation of a single page of the image data.
